(19) United States
(12) Patent Application Publication
(10) Pub. No.: US 2009/0146975 A1
(43) Pub. Date: Jun. 11, 2009

(54) Stylus device capable of switching color

(75) Inventor: Sheng Lung Chang, Jhonghe City (TW)

Correspondence Address: HUDAK, SHUNK & FARINE, CO., L.P.A., 2020 FRONT STREET, SUITE 307, CUYAHOGA FALLS, OH, 44221, US

(73) Assignee: MITAC INTERNATIONAL CORP., Taoyuan (TW)

(21) Appl. No.: 12/315,891

(22) Filed: Dec. 8, 2008

(30) Foreign Application Priority Data
Dec. 10, 2007 (TW) 096147129

(51) Int. Cl. G06F 3/033

(52) U.S. Cl. 345/179; 178/19.01

(57) ABSTRACT

A stylus device capable of switching color is applied to an electronic device provided with a touch panel and comprises a body, several light-emitting devices, and an adjustment portion. The body has a plurality of holes and a pointer. The light-emitting devices are disposed in the hole, and each of which projects the light with various colors. The adjustment portion is disposed on the body, the surface of which has several colors. When the adjustment portion is adjusted to make the pointer point to one of the colors on the adjustment portion, the light-emitting devices generate the color light corresponding to the pointed color for making the body show the pointed color; when the stylus device is used for the touch panel, the color also can be shown on the touch panel.

### FIELD OF THE INVENTION

The present invention relates to a stylus device and particularly to a stylus device capable of switching color.

### BACKGROUND OF THE INVENTION

Referring to FIGS. 1A and 1B respectively for a 3D structural view of a conventional stylus and a schematic view illustrating that the stylus is applied to an electronic device, the conventional stylus 1 is provided with a body 11, a tip 12, and a tail 13. The body 11 is a round rod, the tip 12 is located at a front end of the body 11 and formed into a cone and connected with the body 11. The tail 13 is provided for allowing a user to conveniently take out the stylus 1 from an electronic device 14. While the stylus 1 is used for the electronic device 14, the tip 12 of stylus 1 is made to stay close to a touch panel 15 of the electronic device 14, and when it is used to write on the touch panel 15, traces of lines may be shown on the touch panel 15 of the electronic device 14.

However, it is extremely monotonous to provide only the stylus body. When being used to write with lies of various colors, the stylus must be used to select desired colors, which is very inconvenient.

In order to solve those mentioned above, the stylus is provided with colors for indication so as to make the stylus not monotonous, and then such stylus also can draw the lines of colors corresponding to the color of the stylus while being applied to the electronic device. For this reason, in consideration of improvability of the defects described above, this inventor especially concentrates on studies and operate in coordination with academic theories in addition to the experience in this field for many years, finally providing the present invention for a design reasonable and effective improvement of the defects mentioned above.

Consequently, because of the technical defects of described above, the applicant keeps on carving unflaggingly through wholehearted experience and research to develop the present invention, which can effectively improve the defects described above.

### SUMMARY OF THE INVENTION

In view of the defects of the prior art, one of the objectives of the present invention to provide a stylus device capable of switching color which shows color by using a light-emitting device to project light.

Another objective of the present invention is to provide a stylus device capable of switching color, and an electronic device can detect the color of light emitted from the stylus device by using a detector installed in the electronic device, and display the line drawn by the stylus with the color corresponding to the detected color.

In order to achieve the objective mentioned above, the stylus device capable of switching color in accordance with the present invention is applied to an electronic device provided with a touch panel. The stylus device comprises a body, several light-emitting devices, and an adjustment portion. The body is formed with a plurality of holes and a pointer. The light-emitting devices are disposed in the holes, which respectively project the light with various colors. The adjustment is disposed on the body, the surface of which has several colors. When the adjustment portion is adjusted to make the pointer point to one of the colors on the adjustment portion, the light of the light-emitting devices are mixed to generate the pointed color and enable the body to show the pointed color; when such stylus device is used for the touch panel, the pointed color is shown on the touch panel.

In order to further understand the technical means and effects adopted to achieve the objectives of the present invention, please refer to the detailed description and accompanied drawings according to the present invention. It is believed that the objectives, features, and points of the present invention will be apparent from the description; however, the accompanied drawings are provided for reference and illustration only and not intended to limit the terms or scope of the present invention.

### BRIEF DESCRIPTION OF THE DRAWINGS

FIG. 1A is a three-dimension structural view of a conventional stylus;

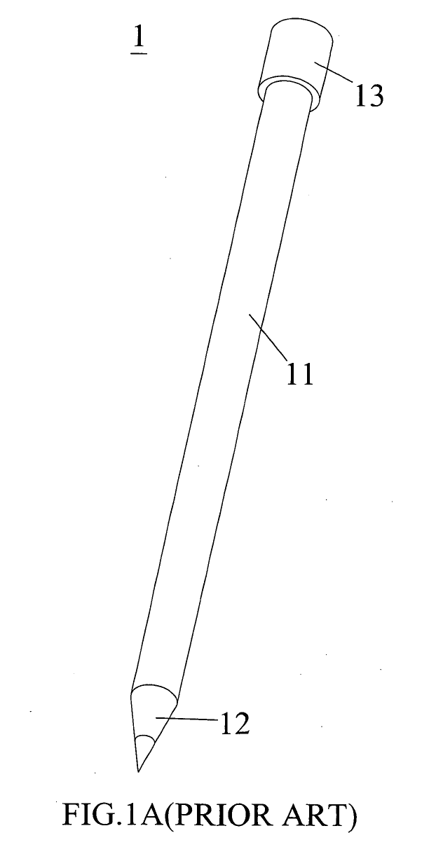

FIG. 1B is a schematic view illustrating that the conventional stylus is applied to an electronic device;

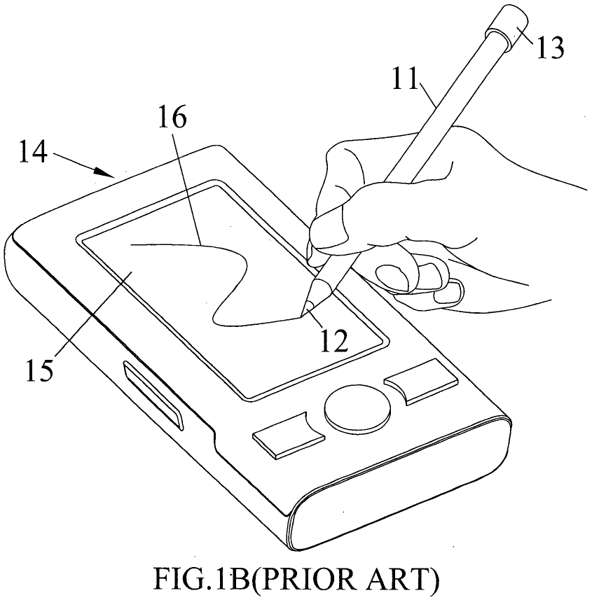

FIG. 2A is a 3D view of a stylus device capable of switching color in accordance with the present invention, wherein different patterns on the adjustment portion represent different colors;

FIG. 2B is a sectional view of the stylus device giving switchover colors in accordance with the present invention;

FIG. 3A is a schematic view illustrating that stylus device of the present invention is operated;

FIG. 3B is a schematic view illustrating that the stylus device of the present invention emits light;

FIG. 3C is a schematic view illustrating that the stylus device of the present invention is applied to the electronic device;

FIG. 4A is a three-dimension view of an embodiment of the stylus device capable of switching color in accordance with the present invention;

FIG. 4B is a sectional view of the stylus device capable of switching color in the preferred embodiment of the present invention; and

FIG. 4C is a schematic view illustrating the mixing of lights given by the light-emitting device on the stylus device capable of switching color in the preferred embodiment of the present invention.

### DETAILED DESCRIPTION OF THE PREFERRED EMBODIMENTS

Now, the present invention will be described more specifically with reference to the following embodiments. It is to be noted that the following descriptions of embodiments of the present invention are presented herein for purpose of illustration and description only; it is not intended to be exhaustive or to be limited to the precise form disclosed.

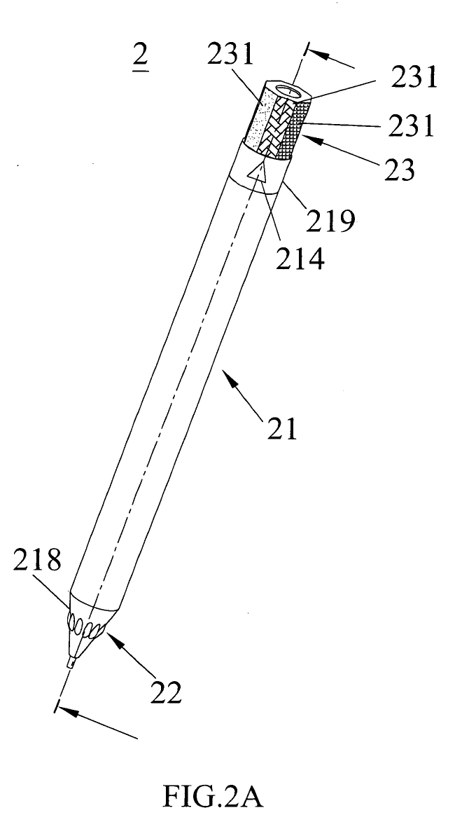

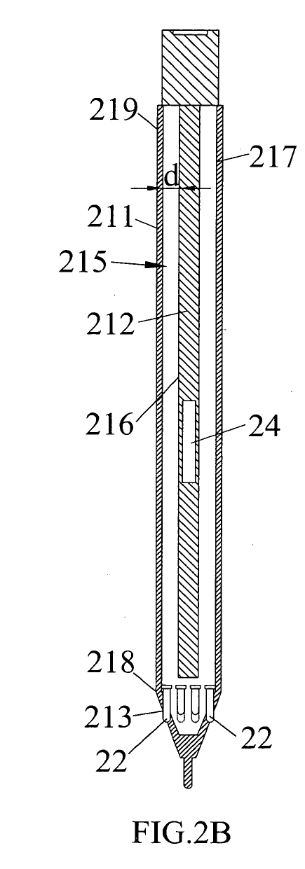

Referring to FIGS. 2A and 2B respectively for a 3D view and a sectional view of a stylus device capable of switching color in accordance with the present invention, the stylus device 2 of the present invention comprises at least a body 21, several light-emitting devices 22, an adjustment portion 23, and a signal transmitter 24.

The body 21 is provided with an outer shell 211, an inner layer 212, a plurality of holes 213, and a pointer 214. The outer shell 211 is transparent and provided with an accommodating space 215. The inner layer 212 is formed in the accommodating space 215, and a surface 216 of the inner layer 212 can reflect light and is kept from an inner side 217 of the outer shell 211 at a distance d so as to form a light channel between the outer shell 211 and the inner layer 212. The holes 213 are formed at a front end 218 of the outer shell 211 and pass through the outer shell 211 and the inner layer 212. The pointer 214 is disposed at the tail 219 of outer shell 211. Preferably, each light-emitting device 22 can be a light-emitting diode (LED) and arranged in the hole 213. These light-emitting devices 22 project the light of various colors. The adjustment portion 23 is disposed on the tail 219 of body 21, the surface of which has several colors 231 each of which is corresponding to the color of light projected by the light-emitting device 22. The signal transmitter 24 is disposed in the stylus device 2 for transmitting signal by, for example, using the manner of Bluetooth, WiFi, or RFID.

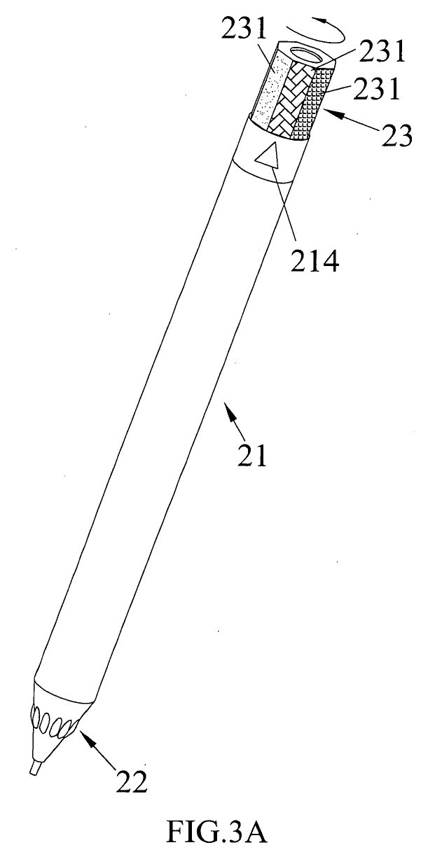

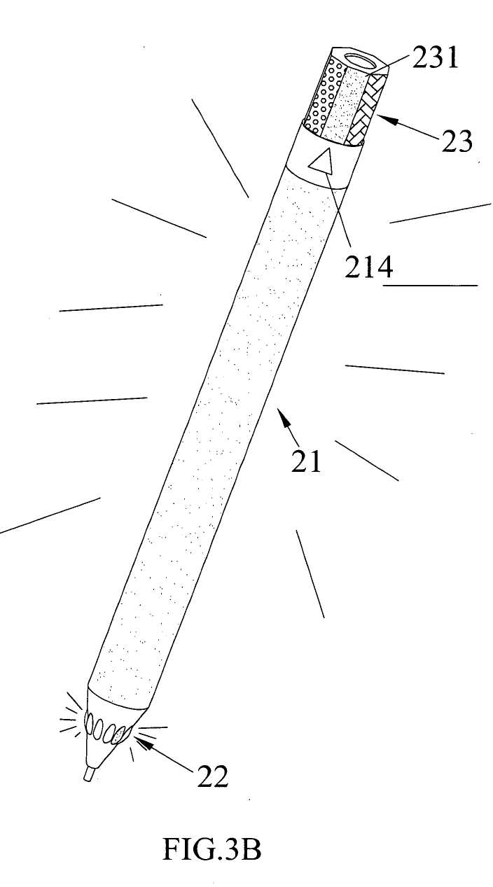

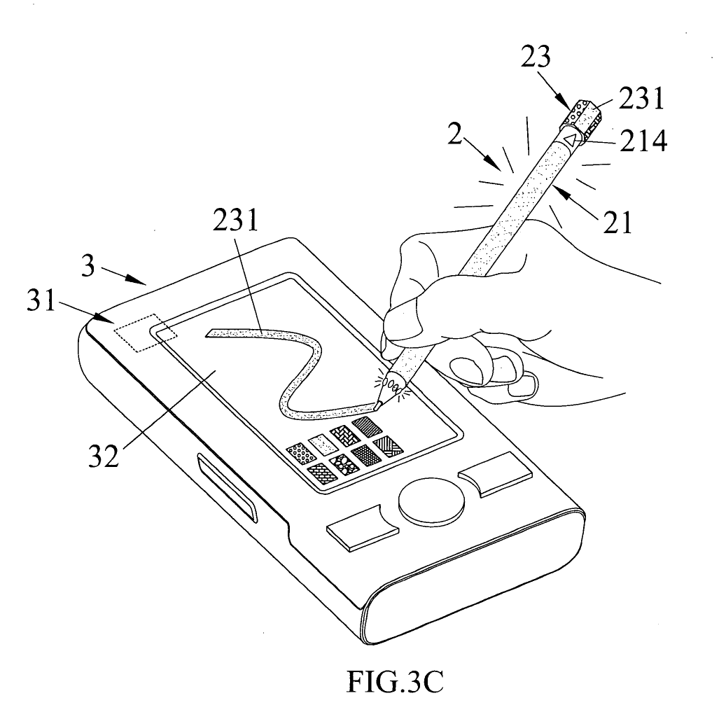

Referring to FIGS. 3A and 3C for schematic views respectively illustrating the stylus device in accordance with the present invention and the service of stylus device applied to the electronic device. In this embodiment, the adjustment portion 23 is rotatable and user can rotate the adjustment portion 23 for selecting color. When the pointer 214 on the outer shell 211 of the body 21 is exactly pointed one of color 231 on the surface of adjustment portion 23, the light-emitting device 22 corresponding to the pointed color 231 is then turned ON for emitting light. The light projected by the light-emitting device 22 may also be refracted in the light channel formed between the outer shell 211 and the inner layer 212 so as to make the whole stylus device 2 emits light. Preferably, the light-emitting devices 22 includes a plurality of different color LEDs, such as a set of red LED, green LED and blue LED or a set of red LED, yellow LED and blue LED, and the light with pointed color 231 can be generated by using one of these LEDs, or by mixing the light form these LEDs.

The signal transmitter 24 further transmits a signal corresponding to the pointed color 231. While the stylus device 2 is used as an input device of an electronic device 3, the electronic device 3 can receive a signal transmitted by the stylus device 2 by a signal receiver 31 installed inside and determine the color indicated by the signal, and then the touch panel 32 of the electronic device 3 can display the pointed color 231 so as to make the lines drawn by the stylus device 2 on the touch panel 32 to be formed with the colors 231 shown on the stylus device 2.

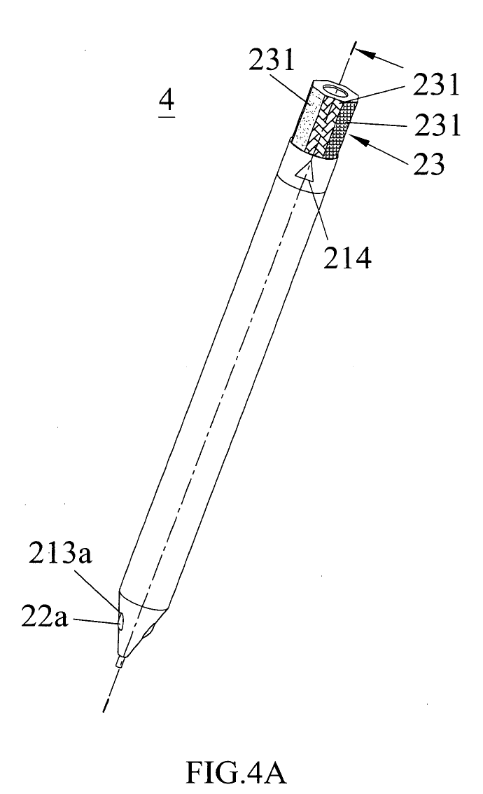

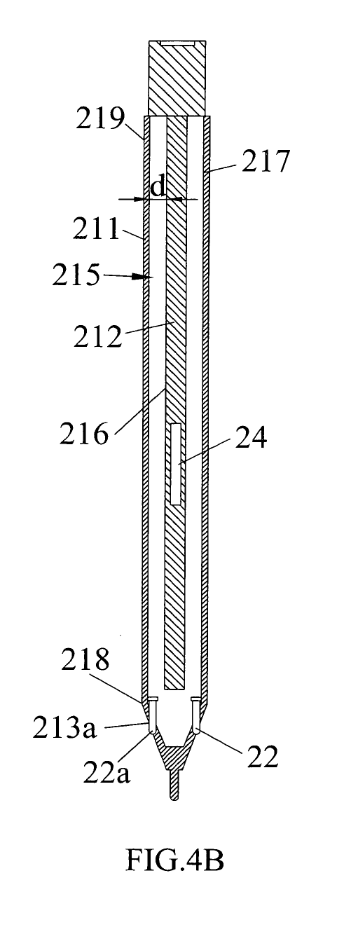

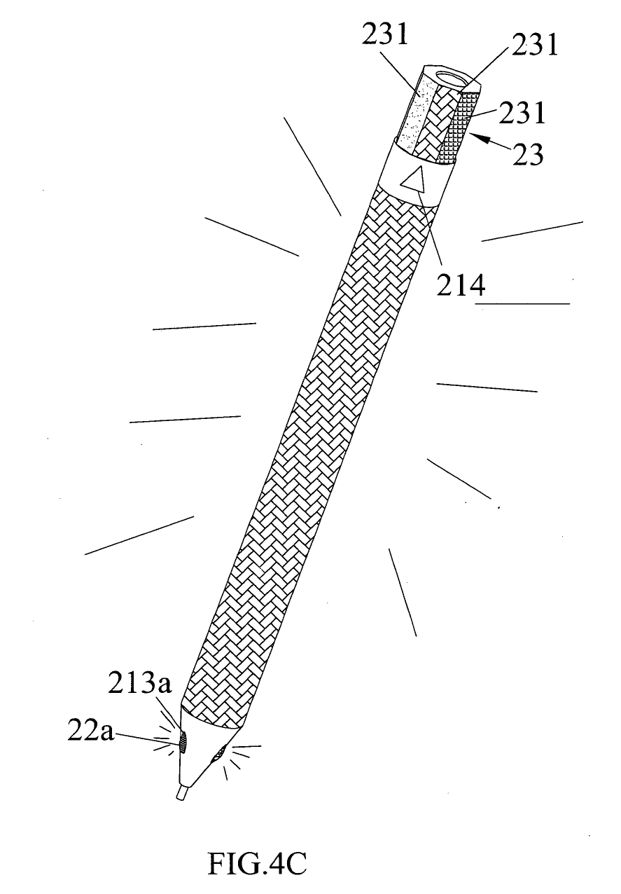

Referring to FIGS. 4A, 4B and 4C respectively for a three-dimension view and a sectional view of an embodiment of the stylus device capable of switching color in accordance with the present invention, and for a schematic view illustrating the mixing of lights of the light-emitting devices of the embodiment of the present invention. Compared with the embodiment in FIG. 2A, the embodiment in FIG. 4A is different in that the body 21 is provided with three holes 213a and the stylus device 4 is provided with three light-emitting devices 22a whose color are red, yellow, and blue, and these light-emitting devices are arranged in holes 213a respectively. When the adjustment portion 23 is rotated to make the pointer 214 on the outer shell 211 of the body 21 point to one of the colors 231 on the surface of adjustment portion 23, at least one light-emitting device 22a projects the light so that the stylus device 4 can show the color 231 which the pointer 214 points to on the surface of adjustment portion 23 by a single light color or mixing light colors, as shown in FIG. 4C, and the signal corresponding to the pointed color 231 is transmitted by the signal transmitter 24. Further, When the stylus device 4 is used in the electronic device 3, as mentioned above, the signal receiver 31 in the electronic device 3 receives the signal transmitted from the stylus device 4 and determines the color indicated by the signal, and then the touch panel 32 of the electronic device 3 can display the pointed color 231 so as to make the lines drawn by the stylus device 2 on the touch panel 32 to be formed with color 231.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A stylus device capable of switching color, applied to an electronic device provided with a touch panel and comprising:
a body;
a plurality of light-emitting devices disposed in the body and respectively projecting the light of various colors; and
an adjustment portion disposed on the body, the surface of the adjustment portion having a plurality of colors corresponding to the colors of light-emitting devices;
wherein, when the adjustment portion is operated to make the pointer point to one of colors on the adjustment portion, at least one of the light-emitting devices emits a light color for making the body show the pointed color; and while the stylus device is used for the touch panel, the color also can be shown on the touch panel.

2. The stylus device of claim 1, wherein the electronic device is a portable electronic device.

3. The stylus device of claim 1, wherein the body is provided with a plurality of holes and the light-emitting devices are disposed in the holes.

4. The stylus device of claim 1, wherein the body is provided with a pointer that is used to point to one of the colors on the adjustment portion.

5. The stylus device of claim 1, wherein the body comprises:
an outer shell having an accommodating space formed with an inner side; and
an inner layer formed in the accommodating space, a surface of the inner layer capable of reflecting the light and kept from the inner side at a distance, and the light generated by light-emitting devices being refracted between the inner side and the surface.

6. The stylus device of claim 1, wherein the light-emitting devices are light-emitting diodes (LED).

7. The stylus device of claim 1, wherein the amount of light-emitting devices is corresponding to the amount of colors on the adjustment portion.

8. The stylus device of claim 1, further comprising a signal transmitter for transmitting a signal corresponding to the color which is pointed.

9. The stylus device of claim 8, wherein the signal transmitter transmits the signal in the manner of Bluetooth transmission, WiFi, or RFID.

10. The stylus device of claim 8, wherein the electronic device is provided with a signal receiver for receiving the signal.

11. A stylus device capable of switching color, applied to an electronic device provided with a touch panel and comprising:
a body;
a plurality of light-emitting devices disposed in the body and respectively projecting the light of various colors; and
an adjustment portion disposed on the body, the surface of which is formed with a plurality of colors;
wherein, when the adjustment portion is adjusted to make the pointer point to one of the colors on the adjustment portion, at least one light generated by the light emitting devices are mixed to make the body show the pointed color; and while the stylus device is used for the touch panel, the color can shown on the touch panel.

12. The stylus device of claim 11, wherein the electronic device is a portable electronic device.

13. The stylus device of claim 11, wherein the body is provided with a plurality of holes and the light-emitting devices are disposed in the holes.

14. The stylus device of claim 11, wherein the body is provided with a pointer that is used to point to one of the colors on the adjustment portion.

15. The stylus device of claim 11, wherein the body comprises:
an outer shell having an accommodating space formed with an inner side; and
an inner layer formed in the accommodating space, a surface of the inner layer capable of reflecting the light and kept from the inner side at a distance, and the light generated by light-emitting devices being refracted between the inner side and the surface.

16. The stylus device of claim 11, wherein the color on the surface of adjustment portion may be projected with the light generated by at least one of the light-emitting devices.

17. The stylus device of claim 11, further comprising a signal transmitter for transmitting a signal corresponding to the color which is pointed.

18. The stylus device of claim 17, wherein the signal transmitter transmits the signal in the manner of Bluetooth transmission, WiFi, or RFID.

19. The stylus device of claim 17, wherein the electronic device is provided with a signal receiver for receiving the signal.

20. A stylus device capable of switching color, applied to an electronic device provided with a touch panel and comprising:
a body;
an adjustment portion disposed on the body, the surface of the adjustment portion having a plurality of colors; and
wherein, when the adjustment portion is operated to make the pointer point to one of colors on the adjustment portion, and while the stylus device is used for the touch panel, the pointed color also can be shown on the touch panel.
